(19) United States
(12) Patent Application Publication
(10) Pub. No.: US 2004/0177513 A1
(43) Pub. Date: Sep. 16, 2004

(54) RAZOR GLIDE STRIP

(76) Inventors: WILLIAM VREELAND, SHELTON, CT (US); JOCHEN THOENE, WUPPERTAL (DE)

Correspondence Address: Richard R. Michaud, McCormick, Paulding & Huber LLP, City Place 11 185 Asylum Street, Hartford, CT, 06103-3402, US

(21) Appl. No.: 09/320,822

(22) Filed: May 27, 1999

(51) Int. Cl. B26B 19/44

(52) U.S. Cl. 30/133

(57) ABSTRACT

Glide strips for wet shave razors in which the glide strips comprise a mixture of polyurethane and polyvinylpyrrolidone in a ratio of less than 3:1. Preferably, the ratio of PVP/PUR is in the range of 3.0-1.0:1. Most preferably, the ratio of PVP/PUR is in the range of 2.5-1.5:1. Glide strips having a ratio within this range provide the benefit of allowing an additive, such as aloe or vitamin E acetate, to be incorporated within the strip in a manner so that it will be capable of depositing the material from the strip on the user's skin during usage. This will provide the benefit to the user of applying a material directly to the skin to enhance the shaving experience. A further embodiment provides a glide strip having a PVP/PUR blend of a certain color and ratio, which ratio will allow the PVP/PUR blend to erode as the razor is used. Upon the erosion of the PVP/PUR blend, the underlying material, of a different color than the PVP/PUR, will be exposed and provide an indication to the user that the razor should be replaced.

### BACKGROUND OF THE INVENTION

1. Field of the Invention

The present invention relates to wet shave razors, and in particular to wet shave razors having glide strips to reduce the friction between the razor and the surface being shaved.

2. Description of Related Art

Wet shave razors have, for many years, utilized materials which reduce the friction between the razor and the surface being shaved. For example, U.S. Pat. No. 4,170,821 to Booth discloses a shaving aid comprising a solid water soluble material which is disposed within a portion of a disposable razor or razor cartridge. Preferably, the shaving aid is disposed in a location adjacent to the cutting edges of the blade or blades. The shaving aid contains a material, such as a skin conditioner, lubricating agent, medicinal agent, etc., which gradually dissolves away during use. One preferred material for incorporation in this shaving aid is polyethylene oxide (“polyox”). During use, the polyox leaches from the shaving aid to coat and lubricate the skin surface being shaved.

U.S. Pat. No. 4,875,287, issued to Creasy et al. discloses a wet shave razor having a skin-engaging portion which contains a hydrogel having water-soluble polymers which are rendered insoluble to prevent dissolution and separation from the surface of the skin-engaging portion upon exposure to water. Upon exposure to water, the coefficient of friction is significantly reduced and the skin-engaging portion becomes extremely lubricious. The hydrogel comprises a mixture of polyurethane and polyvinylpyrrolidone in a manner which prevents the dissolution of the hydrogel. Thus, the skin-engaging portion remains in a constant state and becomes extremely lubricious when wet for an extended period of time. U.S. Pat. No. 5,056,221, issued to Thoene discloses a wet shave razor having a surface with a xerogel which is highly lubricious when wet. The xerogel comprises a mixture of polyurethane (PUR) and polyvinylpyrrolidone (PVP) along with a solvent which evaporates to form the slippery surface of the razor. The mixture is formed with a PVP/PUR ratio of 3:1 to 5:1. These ratios are particularly chosen because they prevent the destruction of the surface which would be caused with other PVP/PUR ratios by leaching of the PVP upon exposure to water. No wear indicator is capable of incorporation within the strip under the parameters of these prior references.

It would be advantageous to provide a glide strip for a razor having the properties of the PVP/PUR strips with the added benefit of the ability to include an additive within the strip which would provide added benefit to the user. It would be further advantageous to provide for such a glide strip which would provide an indication to the user as to the relative usage of the razor.

### SUMMARY OF THE INVENTION

The present invention is directed to glide strips for wet shave razors in which the glide strips comprise a mixture of polyurethane and polyvinylpyrrolidone in a ratio of less than 3:1. Preferably, the ratio of PVP/PUR is in the range of 1.0-3.0:1 Most preferably, the ratio of PVP/PUR is in the range of 2.5-1.5:1. Glide strips having a ratio within this range provide the benefit of allowing an additive, such as aloe or vitamin E acetate, to be incorporated within the strip in a manner so that it will be capable of being deposited on the skin as the strip is worn away under normal shaving usage. This will provide the benefit to the user of applying a material directly to the skin to enhance the shaving experience. A further embodiment of the present invention provides a glide strip having a PVP/PUR blend of a certain color and ratio, which ratio will allow the PVP/PUR blend to erode as the razor is used. Upon the erosion of the PVP/PUR blend, the underlying material, of a different color than the PVP/PUR, will be exposed and provide an indication to the user that the razor should be replaced. The wear rate of the strip can further be influenced by changing the thickness of the PVP/PUR layer. For example, the thickness can be varied from 1 to 100 microns. Preferably the thickness of the glide strip is from about 10 to about 75 microns. Most preferably the thickness of the glide strip is from about 20 to about 60 microns.

### BRIEF DESCRIPTION OF THE DRAWINGS

FIG. 1 is a cross-section of a razor head having a glide strip according to the present invention.

FIG. 2 is a perspective view of a glide strip for use on a razor head.

FIG. 3 is a top view of a glide strip for use on a razor head.

### DETAILED DESCRIPTION OF THE PREFERRED EMBODIMENTS

Reference will now be made to the presently preferred embodiments of the present invention. As used herein, the term wet shave razor comprises those razors which are commonly used with soap, cream or gel and water for shaving. Both disposable razors, in which the entire razor is discarded after a certain number of uses, and permanent razors, in which only the razor cartridge is discarded after a certain number of uses, are included.

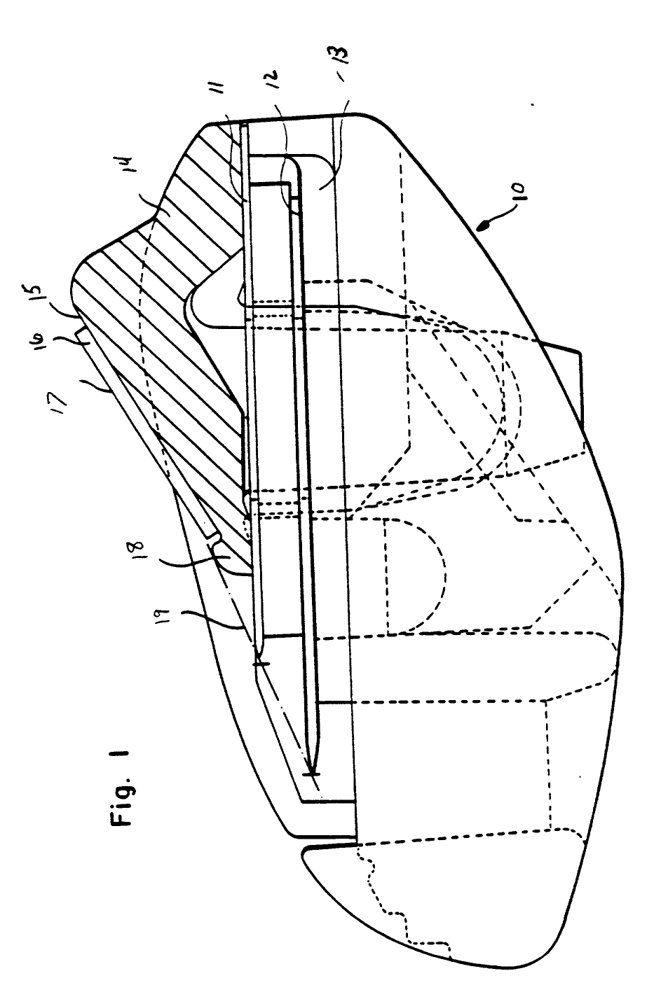

FIG. 1 illustrates a cross-section of a razor head. While FIG. 1 illustrates a razor head having two blade, the glide strip of the present invention may also be utilized on razor heads having one, three or more blades. The illustrated razor head 10 may be either permanently or removably affixed to a razor handle, depending upon the type of razor being utilized. The razor head has two blades 11, 12, which rest on platform 13. Cap 14 covers the blades. A flat surface 15 is shaped on the top of the cap 14. The flat surface is capable of carrying a glide strip 16. The flat surface extends forward to protective lip 18 which protects the front edge of the surface during shaving. The glide strip has a top surface 17 which is coated with a xerogel. Preferably, the glide strip is arranged in relation to the front of cap 14 so that the skin flows smoothly over the blades onto the glide strip, along tangent line 19. Most preferably, the top surface of the glide strip is angled slightly forward to ensure increased skin contact during use.

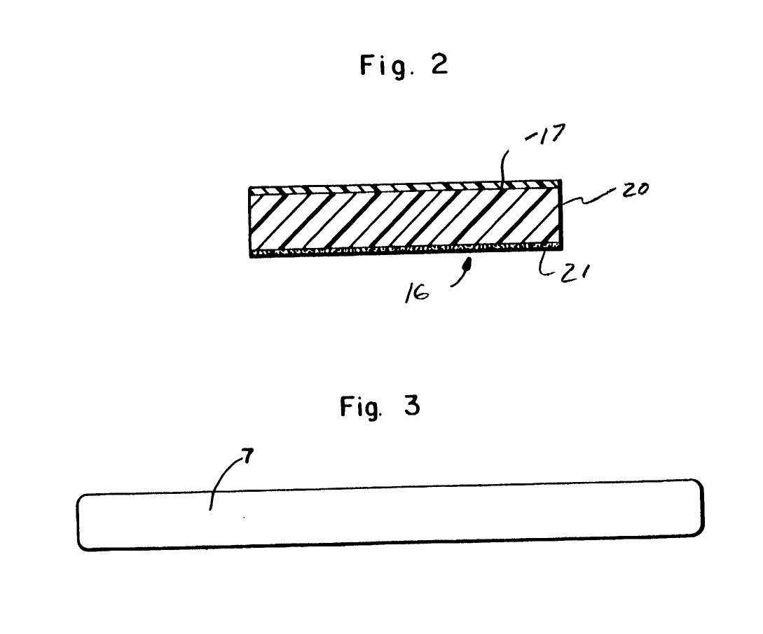

FIGS. 2 and 3 illustrate the glide strip of the present invention. Glide strip 16 comprises a surface layer 17 comprising a xerogel, preferably a PVP/PUR blend. Surface layer 17 is in the range of about 10-75 um thick, preferably in the range of about 20-60 um thick, and most preferably about 50 um+/−10% thick. The thickness of this surface layer may vary depending upon the ultimately desired properties of the glide strip. For example, if it desired that the glide strip will wear away to indicate a change, the wear strip should be thicker so that the glide strip will wear over a longer period of time. The middle layer 20 comprises a polyvinylchloride or polycarbonate foil backing which provides a suitable base for the xerogel. Middle layer 20 is preferably in the range of about 150 um+/−10% thick. Finally, an adhesive layer 21 is provided to affix the glide strip to the razor head. The adhesive layer preferably comprises a waterproof polyacrylate adhesive. Adhesive layer 21 is preferably in the range of about 10-15 um thick.

Xerogels are gels which have lost their fluidity in some manner, such as by evaporation. The basic gel structure is retained and comprises one or more colloidally distributed substance with long or heavily branched particles and a liquid as the dispersion medium. The colloidally distributed substance forms a spatial network in the dispersion medium. By adding the dispersion medium, usually water, the xerogels swell into lyogels. The surface of the material becomes slippery and has a low coefficient of friction. U.S. Pat. No. 5,056,221 provides a detailed description of xerogels and lyogels, and that patent is hereby incorporated herein by reference. Xerogels are comprised of a natural unitary system, such as polysaccharides of high molecular weight, or a homogenous mixture of homopolymers and copolymers of vinyl pyrrolidone, as well as polyurethane. Preferably for the present invention, the xerogel comprises a homogenous blend of PVP and PUR. While various commercially available forms of PVP and PUR may be utilized, preferred versions are Neorez R 940 (31% non-volatile) PUR and PVP Luviskol K 90.

In all previously known blends, the absorption of water during the shaving process does not induce the leaching out of substances because the PVP and PUR are bound together by physical bonding which forms a non-soluble strip when wet. All previously known blends used for shaving purposes comprise a PVP/PUR ratio which must be between 3:1 and 5:1 in order to allow the glide strip to effectively function. In these blends, there is no soluble component and the lubricity of the glide strip does not change despite repeated usage. The ratio of PVP/PUR is critical in that the ratio defines the properties of the glide strip. Generally, the lower the ratio the higher the coefficient of friction and the longer the life of the glide strip. As the ratio is raised, the coefficient of friction is reduced and the life of the strip is shortened. The known range of 3:1 to 5:1 has been disclosed as a balance between durability and optimum friction. At the same time, the known strips provide a low coefficient of friction for the user's comfort. The preferred method for manufacturing the glide strip and applying the xerogel to the base is also disclosed in U.S. Pat. No. 5,0556,221, which has been incorporated herein by reference.

In order to provide a glide strip which is capable of wearing at a predetermined rate and providing the added benefit to the user of dispersing a shaving aid material, such as aloe, vitamin E, a medicinal agent, a fragrance, moisturizer, conditioner, an essential oil or other desired product on the skin, the PVP/PUR ratio must be dramatically changed from the previously known ratios. Specifically, a PVP/PUR ratio of less than 3:1 and preferably less than 2.5:1 provides a glide strip which allows the strip to wear away during the abrasion of skin and hair encountered during shaving. A most preferred PVP/PUR ratio is in the range of from about 2.5:1 to about 1.5:1 at a thickness of about 50 um+/−10%. A ratio within this range will produce a glide strip which is different from previously known glide strips in that the PVP/PUR will wear away at a rate which approximates the average number of shaves normally achieved by a shaver. The shaving aid additive may be incorporated within the PVP/PUR and will deposit onto the user's skin as the strip is wearing away during usage or leach away and onto the user's skin to provide the desired benefit to the user. However, it has been found that the glide strip will still provide the strip with a reduced coefficient of friction for a significant number of uses. Specifically, a PVP/PUR ratio of less than 3:1 will still provide a coefficient of friction of less than 0.25 for numerous shaves.

The following three examples illustrate potential formulations for the glide strip having a PVP/PUR ratios less than 3:1. These examples are merely to provide a better understanding of the invention. Further, the examples are merely illustrative and should not be construed as limiting the scope of the invention.

### EXAMPLE 1

| Neorez R 940 (31% non-volatile) (PUR) | 135 g |
|---|---|
| Diacetone alcohol | 40 g |
| Water | 215 g |
| PVP Luviskol K90 | 100 g |
| Isopropyl alcohol | 510 g |
| | 1000 g |
| Fluorad FC 430 | 1 g |
| Vitamin E acetate | 1% |

Ratio of PVP/PUR=2.4/1

(135×31%)=41.85 g PUR

100 g PVP/41.85 g PUR=2.4 PVP/1 PUR

### EXAMPLE 2

| Neorez R 940 (31% non-volatile) (PUR) | 160 g |
|---|---|
| Diacetone alcohol | 35 g |
| Water | 200 g |
| PVP Luviskol K90 | 100 g |
| Isopropyl alcohol | 510 g |
| | 1000 g |
| Fluorad FC 430 | 1 g |
| Vitamin E acetate | 1% |

Ratio of PVP/PUR=2/1

(160×31%)=49.6 g PUR

100 g PVP/49.6 g PUR=2 PVP/1 PUR

### EXAMPLE 3

| Neorez R 940 (31% non-volite) (PUR) | 200 g |
|---|---|
| Diacetone alcohol | 50 g |
| Water | 250 g |
| PVP Luviskol K90 | 100 g |
| Isopropyl alcohol | 500 g |
| | 1000 g |
| Fluorad FC 430 | 1 g |
| Vitamin E acetate | 1% |

Ratio of PVP/PUR=1.6/1

(200×31%)=62 g PUR

100 g. PVP/62 g. PUR=1.6 PVP/1 PUR

A second benefit which may be obtained by a glide strip having a PVP/PUR ratio of less than 3:1 is that the glide strip may act as a wear indicator. Specifically, a dye or some other form of coloring agent may be added to the PVP/PUR so that the PVP/PUR blend comprising the outside surface of the glide strip is a first color. While any form of coloring agent may be utilized, that coloring agent should be one that is safe for skin-contact. Further, in order to prevent leaching due to mere contact with water, the coloring agent should not be water soluble, but instead should be dispersable in the water/organic mix. The coloring agent is one which should be embedded between the chains of the polymer of the glide strip so that it will only be eroded as a result of repeated shaving operations. The foil backing of the glide strip, which is preferably polyvinylchloride or polycarbonate would be a second, different color. The reduced PVP/PUR ratio will allow the PVP/PUR surface layer of the glide strip to provide a visual indication to the user that it is wearing away and that the user should change razor heads in order to obtain the most comfortable shave. Upon wear of the razor caused by exposure to water during usage, the outer PVP/PUR portion, which is of a first color, would wear away and the foil backing would be exposed. The foil backing would be a second, different color than that of the PVP/PUR portion and thus the user would be able to visually observe the color change of the glide strip and would know that the glide strip was wearing. Consequently, the user would know that the razor should be replaced. This is in direct contrast to the presently utilized glide strips having 3:1-5:1 ratios in that, at those ratios, an additive would wear out very quickly, thus providing an unreliable indication of the dissolution of the PVP/PUR layer.

While there have been described what are presently believed to be the preferred embodiments of the present invention, those skilled in the art will realize that various changes and modifications may be made to the invention without departing from the spirit of the invention, and it is intended to claim all such changes and modifications as fall within the scope of the invention.

We claim:

1. A razor blade unit comprising one or more razor blades, a glide strip comprising a middle layer and a surface for slidably engaging the skin of a user, and a xerogel on the surface, wherein the xerogel comprises a homogenous mixture of homopolymers and copolymers of polyvinylpyrrolidone with polyurethane in which the ratio of the amount of polyvinylpyrrolidone to polyurethane is less than 3:1.

2. A razor blade unit according to claim 1, wherein the ratio of the amount of polyvinylpyrrolidone to polyurethane is less than 2.5:1.

3. A razor blade unit according to claim 2, wherein the ratio of the amount of polyvinylpyrrolidone to polyurethane is in the range of about 2.5:1 to about 1.5

4. A razor blade unit according to claim 3, wherein the glide strip is about 10-75 um thick.

5. A razor blade unit according to claim 4, wherein the glide strip is about 20-60 um thick.

6. A razor blade unit according to claim 5, wherein the glide strip is about 50 um+/−10% thick.

7. A razor blade unit according to claim 2, wherein the xerogel has a coefficient of friction of less than 0.25 when contacted with a hydrous dispersion medium.

8. A razor blade unit according to claim 3, wherein the xerogel further comprises one or more shaving aids selected from the group consisting of aloe, vitamin E, a medicinal agent, a fragrance, moisturizer, conditioner, an essential oil or mixtures thereof.

9. A razor blade unit according to claim 3, wherein the surface layer of the glide strip is of a first color and the middle layer of the glide strip is of a second, different color.
